(19) United States
(12) Patent Application Publication
(10) Pub. No.: US 2020/0128727 A1
(43) Pub. Date: Apr. 30, 2020

(54) SYSTEMS AND METHODS FOR ACTUATING FUNCTIONAL IMPLEMENTS OF VEHICLES AND CONTROLLING VEHICLE SPEEDS

(71) Applicant: ACCELERATED SYSTEMS INC., Waterloo (CA)

(72) Inventors: Willem JAGER, Cambridge (CA); Tim LAMBERT, Guelph (CA)

(21) Appl. No.: 16/663,067

(22) Filed: Oct. 24, 2019

Related U.S. Application Data
(60) Provisional application No. 62/750,869, filed on Oct. 26, 2018.

(51) Int. Cl. A01D 34/00; B60W 50/06; B60W 10/08; B60W 40/105; B60W 20/15

(52) U.S. Cl. CPC A01D 34/006; B60W 50/06; B60W 10/08; B60W 2510/081; B60W 20/15; B60W 2300/15; B60W 2520/28; B60W 40/105

(57) ABSTRACT

Example vehicles with functional implements are provided. An example vehicle includes a driving assembly to propel the vehicle at a vehicle speed, a functional implement assembly to actuate a functional implement at a functional implement speed, a vehicle speed sensor to monitor the vehicle speed, and a controller to control the functional implement assembly to vary the functional implement speed proportionally to the vehicle speed. Another example vehicle includes a driving assembly to propel the vehicle at a vehicle speed, a functional implement assembly to actuate a functional implement at a functional implement speed, a functional implement load sensor to monitor a load delivered to the functional implement, and a controller to control the driving assembly to vary the vehicle speed proportionally to the functional implement load.

### FIELD

The present invention relates to vehicles having functional implements.

### BACKGROUND

Vehicles with functional implements, such as lawn mowers, snow blowers, seed spreaders, and the like, may operate at different levels of speed and performance depending on the speed the vehicle is traveling or the load delivered to the functional implement. For example, in the case of lawn mowers, a lawn mower may adequately cut the grass of a lawn when traveling at a slow speed, but may fail to adequately cut the grass of the same lawn when traveling at a higher speed. The user of the lawn mower may improve performance of the lawn mower by traveling at a slower speed, but traveling at a slower speed may undesirably increase the amount of time required to complete a given task.

### SUMMARY

According to an aspect of the specification, a vehicle includes a driving assembly to propel the vehicle at a vehicle speed, a functional implement assembly to actuate a functional implement at a functional implement speed, a vehicle speed sensor to monitor the vehicle speed, and a controller to control the functional implement assembly to vary the functional implement speed proportionally to the vehicle speed. Thus, the performance of the functional implement may be improved by adjusting the speed of the functional implement based on the speed of the vehicle.

According to another aspect of the specification, a vehicle includes a driving assembly to propel the vehicle at a vehicle speed, a functional implement assembly to actuate a functional implement at a functional implement speed, a functional implement load sensor to monitor a load delivered to the functional implement, and a controller to control the driving assembly to vary the vehicle speed proportionally to the functional implement load. Thus, the performance of the functional implement may be improved by adjusting vehicle speed based on load delivered to the functional implement.

### BRIEF DESCRIPTION OF THE DRAWINGS

FIG. 1 shows a schematic diagram of an example vehicle having an example functional implement.

FIG. 2 shows a flow diagram of an example method for actuating a functional implement of a vehicle.

FIG. 3 shows a flow diagram of another example method for actuating a functional implement of a vehicle.

FIG. 4 shows a schematic diagram of another example vehicle having an example functional implement, the vehicle being a manual-propulsion vehicle.

FIG. 5 shows a schematic diagram of yet another example vehicle having an example functional implement, the vehicle including a load sensor to monitor load on the functional implement.

FIG. 6 shows a flow diagram of yet another example method for controlling vehicle speed of a vehicle having a functional implement.

FIG. 7 shows a flow diagram of yet another example method for controlling vehicle speed of a vehicle having a functional implement.

### DETAILED DESCRIPTION

A vehicle may comprise mobility devices which enable the vehicle to move relative to the environment or terrain external to the vehicle. Examples of mobility devices may include one or more wheels, tracks, legs, and the like. Some vehicles may comprise a functional implement, which may allow the vehicle to interact with the environment or terrain external to the vehicle. Some examples of such vehicles with functional implements include riding lawn mowers, walk-behind lawn mowers, riding snow blowers, walk-behind snow blowers, riding lawn tractors, and the like.

In the example of lawn mowers, the cutting blade may form all or part of the functional implement. For example, a riding lawn mower may comprise one or more decks that include one or more cutting blades. The cutting blades may be sized and shaped to cut vegetation (e.g., grass, weeds, etc.). Moreover, in the example of snow blowers, the augers may form all or part of the functional implement. Such vehicles and their functional implements may be powered by electric motors.

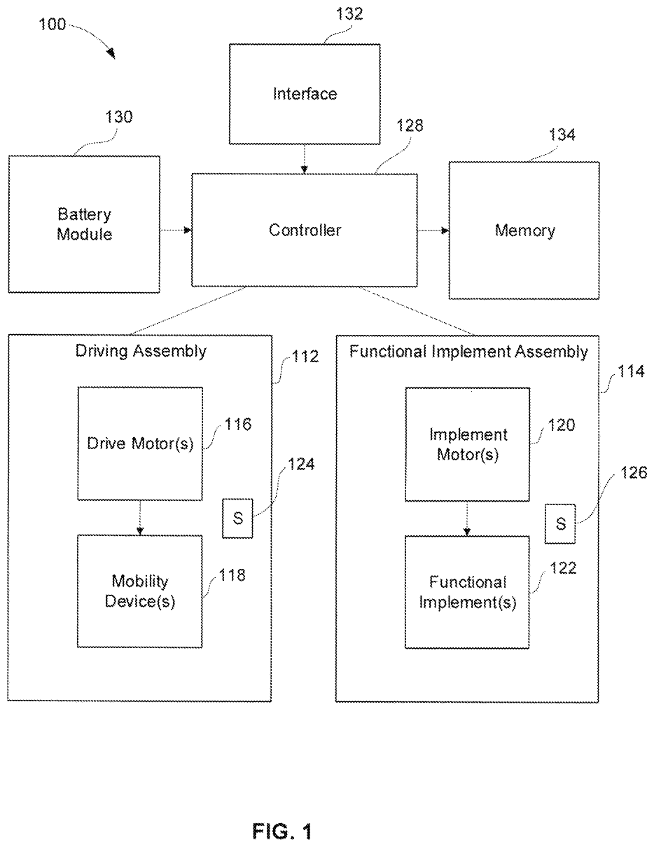

Referring to FIG. 1, a schematic diagram of an example electrically-powered vehicle 100 is shown. In some examples, the vehicle 100 may be an electric riding lawn mower. In other examples, the vehicle 100 may be an electric walk-behind lawn mower having self-propulsion, an electric riding snow blower, an electric walk-behind snow blower having self-propulsion, or another electric vehicle having a functional implement.

As illustrated, the vehicle 100 includes a driving assembly 112. The driving assembly 112 includes at least one electric drive motor 16, and at least one mobility device 118 that is driven by the drive motor 116. In some examples mobility device 118 may comprise one or more wheels. Moreover, in some examples, the driving assembly 112 may include a shaft, a transmission or gear assembly, and/or other suitable components linking the drive motor 116 and the mobility device 118. In other examples, the driving assembly 112 may include one or more individual electric hub motors, in which the drive motor 116 and the mobility device 118 may be integrated as one device.

Although not shown, the driving assembly 112 of the vehicle 100 may also include steering systems for controlling vehicle movement. In some examples, these systems may operate a set of steerable wheels, for example, the front wheels, rear wheels, or both the front and rear wheels. In addition, in some examples these steering systems may comprise a steering wheel (not shown) to allow an operator to turn the steering wheel and steer the riding lawn mower by pivoting the steerable wheels.

As illustrated, the vehicle 100 includes a functional implement assembly 114. In some examples, functional implement assembly 114 may comprise a vegetation cutting assembly. In other examples, electric vehicles may include an accessory or implement assembly to carry out a desired function other than cutting vegetation. For example, in the case of snow blowers, an impeller or a combination of an auger and an impeller may be implements used to clear snow.

The functional implement assembly 114 includes at least one implement motor 120, and at least one functional implement 122 that is driven by the implement motor 120. In some examples, functional implement 122 may comprise one or more cutting blades to cut vegetation such as grass, weeds, and the like. Furthermore, in some examples, the cutting blade may be a rotary-type blade configured to rotate about an axis intersecting a cutting plane defined by the rotating blade(s). In some examples, the axis may be about perpendicular to the cutting plane.

Although the drive motor 116 and the implement motor 120 are shown and described as separate elements, in other examples, a single electric motor may be implemented to deliver mechanical energy to both the mobility device 118 and the functional implement 122. In such examples, a transmission or gear assembly (e.g., a continuously variable transmission system) may be used to decouple and distribute mechanical energy between the mobility device 18 and the functional implement 122.

The vehicle 100 also includes a controller 128 that is connected to the driving and functional implement assemblies 112, 114. In some examples, the controller 128 may be responsible for delivering current to the motors 116, 120, among other things. In various examples, the controller 128 may be implemented on a programmable processing device, such as a microprocessor or microcontroller, Central Processing Unit (CPU), Digital Signal Processor (DSP), Field Programmable Gate Array (FPGA), application-specific integrated circuit (ASIC), and the like.

A load sensor may be arranged within the controller 128 or between the controller 128 and the drive motor 116 to monitor the current load delivered to the drive motor 116. Similarly, a load sensor may be arranged within the controller 128 or between the controller 128 and the implement motor 120 to monitor the current load delivered to the implement motor 120. For example, shunts can be used to monitor the current loads being supplied to the motors 116, 120.

It should be appreciated that two operational characteristics of the vehicle 100 are vehicle speed and deck or blade speed.

Vehicle speed may refer to the speed that the at least one mobility device 118 such as a wheel is being rotated to propel the vehicle 100. Typically, the vehicle speed may vary between zero, when no current is being directed to the motor 116 and the wheel is motionless, and higher speeds. Deck or blade speed may refer to the speed that the at least one functional implement 122, such as a cutting blade, is operated to cut vegetation. Typically, the blade speed may vary between zero, when no current is being directed to the motor 120 and the cutting blade is about motionless, and a regulated maximum blade speed at which the cutting blade is moving at the fastest speed permitted by safety regulations. In some examples, the regulated maximum blade speed may be a maximum tip speed for a rotary lawn mower blade that is about 19,000 feet per minute. In some examples the regulated maximum blade speed may be expressed as rotations or revolutions (of the blade) per minute.

The driving assembly 112 may further include a vehicle speed sensor 124 to monitor the vehicle speed of the vehicle 100. In some examples, the vehicle speed sensor 124 may comprise an optical sensor arranged adjacent to the wheel and configured to monitor the speed at which the wheel is rotating. In other examples, the vehicle speed sensor 124 may be a Hall Effect sensor or other electromechanical sensor arranged to detect rotor position within the motor 116, which information can be correlated to the vehicle speed.

Similarly, the functional implement assembly 114 may further include a functional implement speed sensor 126 configured to monitor a functional implement speed of the vehicle 100. In the example of a lawn mower, the functional implement speed may comprise the cutting blade speed. In some examples, the functional implement speed sensor 126 may be an optical sensor arranged adjacent to the cutting blade and configured to monitor the speed in which the cutting blade is rotating. In other examples, the functional implement speed sensor 126 may be a Hall Effect sensor or other electromechanical sensor arranged to detect rotor position within the motor 120, which information can be correlated to the blade speed.

The speed sensors 124, 126 are both connected to the controller 128 to provide vehicle speed and blade speed information to the controller 128. However, it is contemplated that in other examples, the speed sensors 124, 126 may be omitted, and drive and blade speed may be monitored based on the current load delivered to the motors 116, 120.

As illustrated, a battery module 130, an interface 132 and a memory 134 are also connected to the controller 128. The battery module 130 may comprise a single battery, or may include a plurality of separate batteries, connected in series or in parallel to one another. The battery module 130 may be rechargeable, and the controller 128 may be configured to monitor the capacity of the battery module 130 between 100% state of charge and a depleted state. In the present example, the battery module 130 may power the vehicle 100, including the controller 128, driving assembly 112, and functional implement assembly 114. However, in other examples, the battery module 130 may be part of a hybrid power system which powers the vehicle 100 in part through battery power, and in part through an alternative power source, such as gasoline, diesel, or any suitable power source. In still other examples, the driving assembly 112 and/or functional implement assembly 114 may be powered by such an alternative power source, with the battery module 130 providing power to the controller 128 and other electronic systems, such as the sensors 124, 126. Thus, variations to how the vehicle 100 is powered are contemplated.

The interface 132 may comprise one or a combination of communications, input, and output devices. For example, interface 132 may include a display for presenting information to the operator, for example, vehicle speed and blade speed information, state of charge of the battery module 130, and so on. The interface 132 may also include an input device such as a keypad or other control for receiving information from the operator, for example, to establish vehicle and blade speed setpoints, as described below. In some examples, the interface 132 may be a touch screen.

Moreover, in some examples interface 132 may comprise a communications interface for communication with an input and/or output terminal external to vehicle 100. For example, interface 132 may be to communicate with a mobile computing device of an operator, such as a smart phone, and the like. The operator may in turn use this mobile device as an output and/or input terminal for monitoring and controlling vehicle 100. Furthermore, in some examples, interface 132 may be onboard of or integrated with controller 128.

In addition, the memory 134 may be configured to store instructions regarding control of the vehicle 100, and further may be used to store data pertaining to operation of the vehicle 100 (including, for example, speed information from speed sensors 124, 126, measured on a continuous, periodic and/or intermittent basis). The memory 134 may include non-transitory storage media, both volatile and non-volatile, including but not limited to, random access memory (RAM), dynamic random access memory (DRAM), static random access memory (SRAM), flash memory, magnetic media, and optical media, and other suitable data storage devices. In some examples, memory 134 may be onboard of or integrated with controller 128. Furthermore, the various steps set out in method 200 or method 300 and the other methods described herein may be stored as machine-readable or computer-readable instructions on the memory 134, and may be carried out by the controller 128 as one iteration or as a loop on a continuous, periodic and/or intermittent basis.

The vehicle speed may determine that rate at which external materials (e.g. grass, snow, and the like) or other types of work is presented to the functional implement. In order to maintain a predetermined or acceptable level of performance, the functional implement may vary its operating speed corresponding to the change in the vehicle speed. For example, where the vehicle comprises a lawn mower, a higher vehicle speed may mean that the blade(s) have less time to interact with and provide an acceptable cut of any given area of grass. To compensate for this shortened cutting time, the blade speed may be increased to increase the frequency of interactions between the glass and the blade (i.e. cutting) per unit area per unit time. Similar changes to the operating speed of the functional implement may be used in the cases of snow blowers or other types of electrically powered vehicles with functional implements.

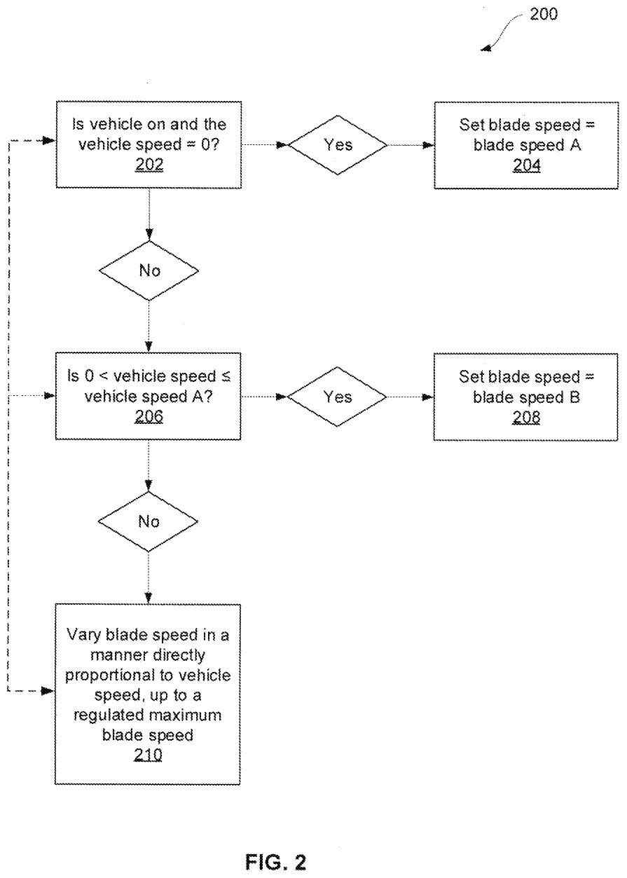

Now referring to FIG. 2, a flow diagram of an example method 200 for actuating a functional implement of a vehicle is shown. For convenience, reference may be had to the vehicle 100 of FIG. 1 throughout the description of the method 200, but this is not limiting, and it is to be understood that the method 200 may be applied to other vehicles.

The controller 128 may control vehicle 100 according to the method 200 in order to control the blade speed of a lawn mower as a function of the vehicle speed of the mower. At block 202, the controller may determine whether the vehicle is on and the vehicle speed is zero. If the determination is affirmative, then the controller may move to block 204, where the blade speed is set to a blade speed A. Blade speed A may comprise an idling speed that is below operational or optimal cutting speed. Setting the blade speed to an idle speed may reflect a determination by the controller that since the vehicle is not moving, it is likely that the operator is not yet engaged in cutting grass. Running the blade at such a low idle speed may reduce power consumption, increase the overall operating efficiency of the vehicle, and lengthen the operating time of the battery between charges.

In some examples, this idle blade speed may be in the range of about 2000 rpm to about 2500 rpm. Moreover, in some examples the idle speed may be settable or definable by the operator of the vehicle. In addition, in some examples the idle blade speed may be set to zero.

If, on the other hand, the determination at block 202 is negative, then the controller may move to block 206, where the controller determines whether the vehicle speed is greater than zero and less than or equal to a vehicle speed A. Vehicle speed A may define a vehicle low speed threshold, below which threshold adjusting the blade speed as a function of vehicle speed may not result in appreciable gains in blade's cutting performance. In some examples, the vehicle low speed threshold may be a speed greater than zero and less than or equal to about 3 mph. Moreover, in some examples the vehicle low speed threshold may be a speed greater than zero and less than or equal to about 2 mph.

If the controller makes an affirmative determination at block 206 that the vehicle speed is at or below the vehicle low speed threshold, the controller may move to block 208 where the blade speed may be set to a blade speed B. Blade speed B may comprise a blade low operating speed, which produces an acceptable cut at vehicle speeds at or below the vehicle low speed threshold. In some examples, the blade low operating speed may be about 3000 rpm. In some examples, one or both of vehicle speed A and blade speed B may be definable or settable by the operator of the vehicle.

If, on the other hand, the determination at block 206 is negative, i.e. if the vehicle speed is greater than vehicle speed A, then the controller may move to block 210 where the controller monitors the vehicle speed and varies the blade speed in a manner directly proportional to the vehicle speed, up to the regulated maximum blade speed. Varying the blade speed in a manner that is directly proportional to the vehicle speed may comprise generally increasing the blade speed if the vehicle speed increases, and decreasing the blade speed if the vehicle speed decreases.

The blade speed may be varied as a function of the vehicle speed linearly, exponentially, in a step-wise manner, or in another suitable manner. The direct proportionality between the blade speed and the vehicle speed is intended to indicate the direction of change of the blade and vehicle speeds (i.e. that an increase in vehicle speed generally causes an increase in the blade speed, and vice versa), and is not intended to limit the manner or mathematical function (e.g. linear, exponential, step-wise, etc.) according to which the blade speed is varied as a function of the vehicle speed.

Increasing the blade speed when the vehicle speed increases may allow the blade sufficient interactions with the grass to effect an acceptable quality of cut in the shorter cut time per unit area allowed by the faster moving vehicle. Similarly, reducing the blade speed when the vehicle is moving more slowly may reduce power consumption and increase operating efficiency compared to the scenario where the blade is operated at a maximum blade speed (or a blade speed that is higher than need to effect an acceptable cut quality at the given vehicle speed) regardless of vehicle speed. As such, method 200 may allow a lawn mower to operate more efficiently and to maintain a given, acceptable cut quality despite changes in the vehicle speed of the lawn mower.

In other words, the controller may control the functional implement assembly to vary the functional implement speed directly proportional to the vehicle speed by the following. The controller determines whether the vehicle is on and that a current vehicle speed is substantially zero, and in response to determining that the vehicle is on and the current vehicle speed is substantially zero, sets the functional implement speed to a first functional implement speed. Further, the controller determines whether the current vehicle speed is greater than zero and less than a first vehicle speed, and in response to determining that the current vehicle speed is greater than zero and less than the first vehicle speed, sets the functional implement speed to a second functional implement speed, the second functional implement speed greater than the first functional implement speed. Further, in response to determining that the current vehicle speed is not greater than zero and less than the first vehicle speed, the controller varies the functional implement speed directly proportional to the vehicle speed. An interface of the vehicle may enable a user to set the first vehicle speed, the first functional implement speed, and the second functional implement speed.

In addition, in some examples at block 210 the increases to the blade speed in response to increases in the vehicle speed may be capped at a preset or user-defined maximum operating blade speed that is lower than the regulated maximum blade speed. This maximum operating blade speed may be chosen depending on factors such the grass conditions, and the like. For example, thicker grass may suggest using a higher maximum operating blade speed to effect a cut of acceptable quality, while thinner grass or vegetation may suggest using a relatively lower operating blade speed to effect a cut of acceptable quality.

In some examples, the controller may continue to monitor the vehicle speed to determine if the vehicle speed falls to or below vehicle speed A, in which case the controller may move from block 210 back to block 206. If, on the other hand, the vehicle speed falls back to zero, the method may move back to block 202, from either block 210 or block 206.

In addition, while method 200 is described in the context of a lawn mower, it is contemplated that method 200 may also be performed by other types of electric vehicles with functional implements, such as snow blowers and the like. Moreover, while method 200 is described as being performed by the controller of a vehicle, it is contemplated that other components or modules of a vehicle may perform method 200 instead of or in addition to the controller.

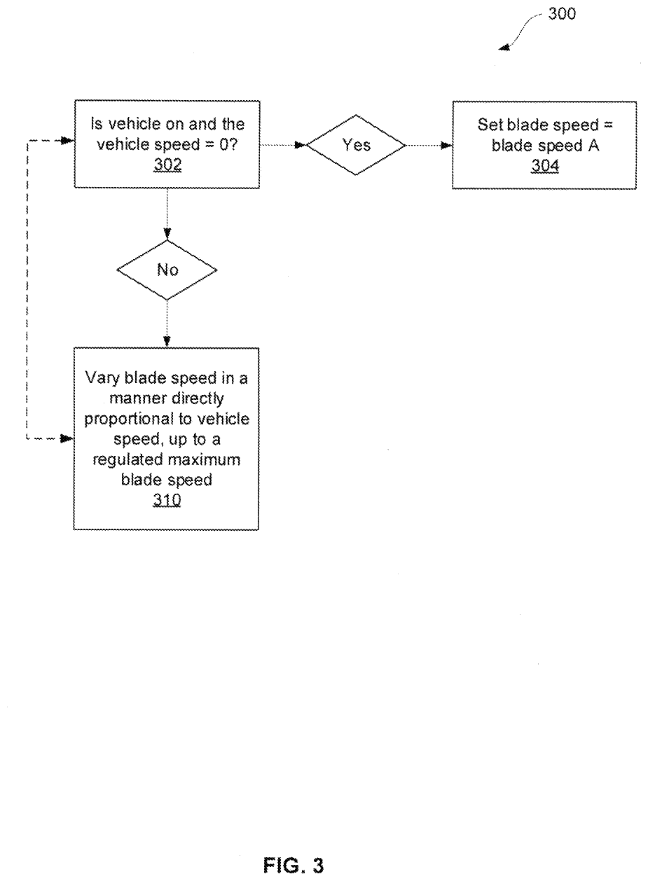

Moreover, in some examples method 200 need not comprise blocks 206 and 208, and may move directly from block 202 to block 210 upon a determination at block 202 that the vehicle is on and the vehicle speed is greater than zero. An example of such a method is described below with reference to FIG. 3.

Now referring to FIG. 3, a flow diagram of another example method 300 for actuating a functional implement of a vehicle is shown. The method 300 is similar to the method 200 of FIG. 2, without blocks 206 and 208.

Thus, at block 302, the controller may determine whether the vehicle is on and the vehicle speed is zero. If the determination is affirmative, then the controller may move to block 304, where the blade speed is set to a blade speed A. Blade speed A may comprise an idling speed that is below operational or optimal cutting speed.

If, on the other hand, the determination at block 302 is negative, i.e. if the vehicle speed is greater than zero, then the controller may move to block 310, where the controller monitors the vehicle speed and varies the blade speed in a manner directly proportional to the vehicle speed, up to the regulated maximum blade speed. Varying the blade speed in a manner that is directly proportional to the vehicle speed may comprise generally increasing the blade speed if the vehicle speed increases, and decreasing the blade speed if the vehicle speed decreases. The idling blade speed A, and the varying blade speed, may be similar to the blade speed A and the varying blade speed described with reference to FIG. 2.

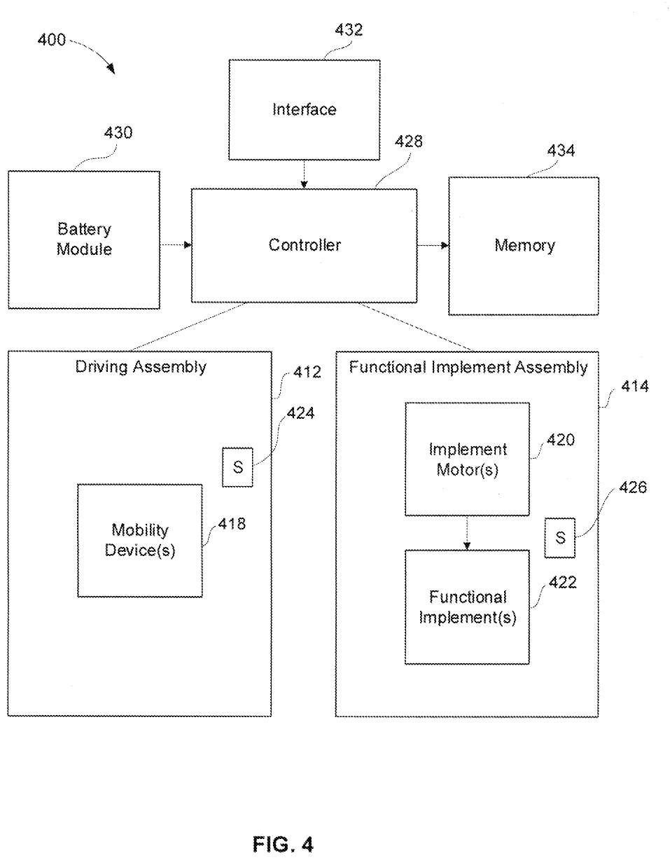

FIG. 4 is a schematic diagram of another example electrically-powered vehicle 400. The vehicle 400 is similar to the vehicle 100, with like elements numbered in the “400” series rather than the “100” series, and thus includes a driving assembly 412, functional implement assembly 414, at least one mobility device 418, at least one implement motor 420, at least one functional implement 422, a vehicle speed sensor 424, a functional implement speed sensor 426, a controller 428, a battery module 430, an interface 432, and a memory 434. For further description of these elements, reference to the vehicle 100 of FIG. 1 may be had.

However, in contrast to the vehicle 100, the vehicle 400 does not include a drive motor to propel the vehicle 400. Thus, the vehicle 400 may be a walk-behind lawn mower, walk-behind snow blower, and the like, without self-propulsion. That is, the vehicle 400 is propelled by manual propulsion, or in other words, is propelled by the user.

Similar to the vehicle 100, the vehicle speed sensor 424 may monitor the vehicle speed of the vehicle 400, such as by measuring the speed of a wheel of the vehicle 400 rotating, and the controller 428 may vary the operating speed of the functional implement 422 corresponding to the change in the vehicle speed, for example, according to the method 200 of FIG. 2 or the method 300 of FIG. 3.

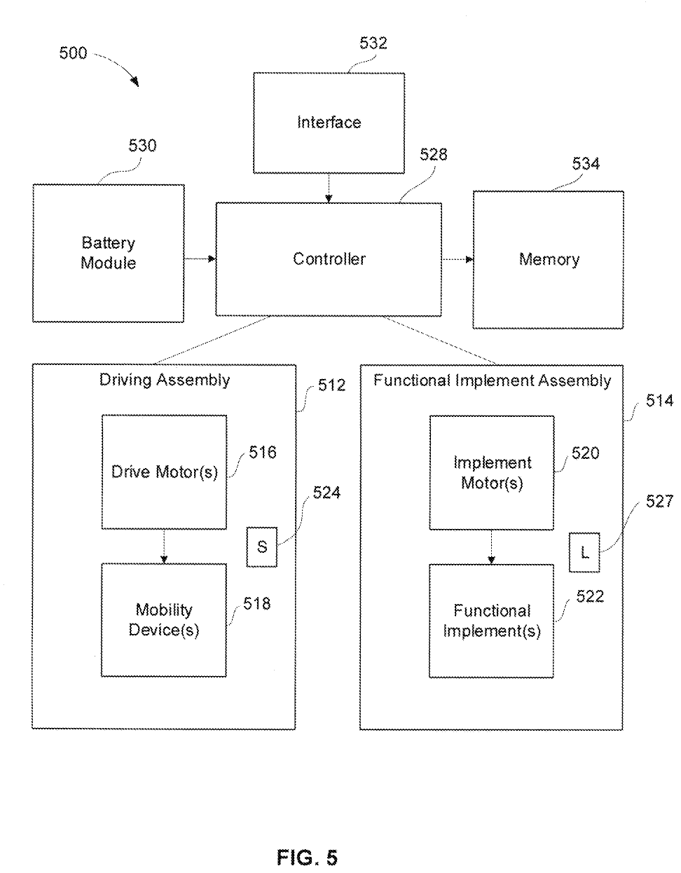

FIG. 5 is a schematic diagram of another example electrically-powered vehicle 500. The vehicle 500 is similar to the vehicle 100, with like elements numbered in the “500” series rather than the “500” series, and thus includes a driving assembly 512, functional implement assembly 514, at least one mobility device 518, at least one implement motor 520, at least one functional implement 522, a vehicle speed sensor 524, a controller 528, a battery module 530, an interface 532, and a memory 534. For further description of these elements, reference to the vehicle 100 of FIG. 1 may be had.

However, in contrast to the vehicle 100, the vehicle 500 includes a vehicle a functional implement load sensor 527 which is to monitor the current load delivered to the implement motor 520. For example, a shunt can be used to monitor the current load. The vehicle 500 may further include a functional implement speed sensor to monitor the speed at which the functional implement is rotating.

The current load delivered to the functional implement 522 may indicate the rate at which materials (e.g. grass, snow, and the like) or other types of work is presented to the functional implement 522. A high load delivered to the functional implement 522 may indicate that the functional implement 522 is struggling with its workload. For example, where the vehicle 500 comprises a snowblower, a high load on the functional implement 522 may indicate that the vehicle 500 is encountering a high volume of snow that the functional implement 522 (e.g., auger) may have difficulty clearing.

In order to maintain a predetermined or acceptable level of performance, the mobility device 518 may vary its operating speed corresponding to a change in functional implement load. That is, the controller 528 may control the drive motor 516 to vary the vehicle speed of the vehicle 500 in response to a change in the current load delivered to the functional implement 522 as detected by the functional implement load sensor 527. In the example where the vehicle 500 comprises a snowblower that is encountering a high volume of snow, the controller 528 may cause the drive motor 516 to reduce the vehicle speed of the vehicle 500 to allow the functional implement 522 to have sufficient time to clear the snow.

Similar changes to the operating speed of the functional implement may be used in the cases of seed spreaders or other types of electrically powered vehicles with functional implements. In an example in which the vehicle 500 comprises a seed spreader, a low load on the functional implement 522 (e.g. spreader disc) may indicate that the vehicle 500 is running low on seed to spread, which may indicate that the functional implement 522 is spreading less seed per unit of distance traveled by the vehicle 500. In order to maintain a consistent level of seed spreading, the controller 528 may cause the drive motor 516 to reduce the vehicle speed to allow the smaller amount of seed to be spread more evenly.

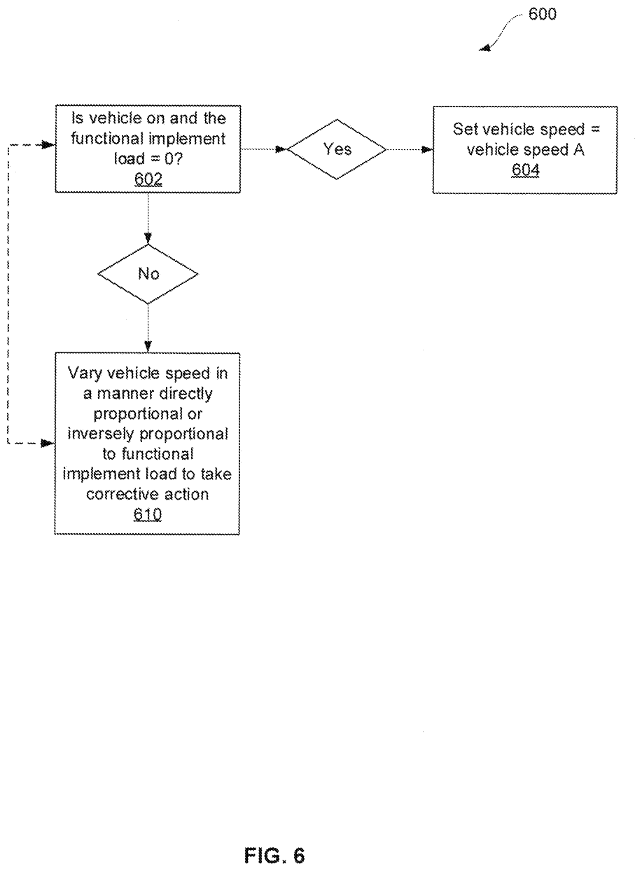

Now referring to FIG. 6, a flow diagram of another example method 600 for controlling vehicle speed of a vehicle having a functional implement. For convenience, reference may be had to the vehicle 500 of FIG. 5 throughout the description of the method 600, but this is not limiting, and it is to be understood that the method 600 may be applied to other vehicles.

The controller 528 may control vehicle 500 according to the method 600 in order to control the speed of a snow blower or seed spreader as a function of the load of the functional implement.

At block 602, the controller may determine whether the vehicle is on and the functional implement load is zero. If the determination is affirmative, then the controller may move to block 604, where the vehicle is set to a vehicle speed A. Vehicle speed A may comprise an idling speed.

If, on the other hand, the determination at block 602 is negative, i.e. if the functional implement load is greater than zero, then the controller may move to block 610, where the controller monitors the load on the functional implement and varies the vehicle speed in a manner that is either directly proportional or inversely proportional to the load on the functional implement.

Varying the vehicle speed in a manner that is directly proportional to the load on the functional implement may comprise generally increasing the vehicle speed if the load on the functional implement increases, and decreasing the vehicle speed if the load on the functional implement decreases. Varying the vehicle speed in a manner that is inversely proportional to the load on the functional implement may generally comprise the inverse of the above.

In examples in which the vehicle comprises a snowblower, the vehicle speed may be varied in a manner that is inversely proportional to the load on the functional implement, as described above with reference to FIG. 5. In examples in which the vehicle comprises a seed spreader, the vehicle speed may be varied in a manner that is directly proportional to the load on the functional implement, as described above with reference to FIG. 5. In either case, the vehicle speed is varied in a manner that takes corrective action so that the functional implement achieves a predetermined or acceptable level of performance.

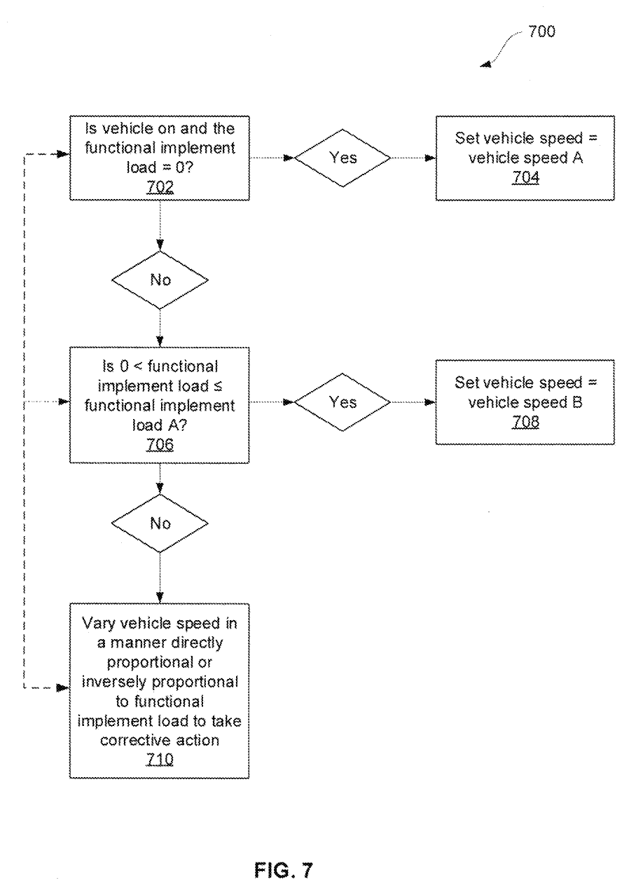

FIG. 7 shows a flow diagram of another example method 700 controlling vehicle speed of a vehicle having a functional implement. The method 700 is similar to the method 600 of FIG. 6, and thus includes blocks 702, 704, and 710 which are similar to blocks 602, 604, and 610 of FIG. 6, respectively.

However, in contrast to the method 600, in the method 700, when block 702 is answered in the negative, that is, when the load on the functional implement is greater than zero, the controller may move to block 706. At block 706, the controller determines whether the load on the functional implement is greater than zero and less than functional implement load A. Functional implement load A may define a low load threshold, below which threshold adjusting the vehicle speed as a function of functional implement load may not result in appreciable gains in the functional implement's performance.

If the controller makes an affirmative determination at block 706 that the functional implement load is at or below the low load threshold, the controller may move to block 708 where the vehicle speed may be set to a vehicle speed B. Vehicle speed B may comprise a low vehicle speed, which produces an acceptable performance of the functional implement at or below the low load threshold. In some examples, one or both of functional implement load A and functional implement load B may be definable or settable by the operator of the vehicle.

In other words, the controller may control the driving assembly to vary the vehicle speed directly proportional to the functional implement load by the following. The controller determines whether the vehicle is on and that a current functional implement load is substantially zero, and in response to determining that the vehicle is on and the current functional implement load is substantially zero, sets the vehicle speed to a first vehicle speed. Further, the controller determines whether the current functional implement load is greater than zero and less than a first functional implement load, and in response to determining that the current functional implement load is greater than zero and less than the first functional implement load, sets the vehicle speed to a second vehicle speed, the second vehicle speed greater than the first vehicle speed. Further, in response to determining that the current functional implement load is not greater than zero and less than the first functional implement load, the controller varies the vehicle speed proportionally to the vehicle speed. An interface of the controller may enable a user to set the first vehicle speed, the first functional implement speed, and the second functional implement speed.

Thus, it may be seen that the performance of the functional implement may be improved by adjusting the speed of the functional implement based on the speed of the vehicle, or by adjusting vehicle speed based on load delivered to the functional implement.

It should be recognized that features and aspects of the various examples provided above can be combined into further examples that also fall within the scope of the present disclosure. The scope of the claims should not be limited by the above examples but should be given the broadest interpretation consistent with the description as a whole.

1. A vehicle comprising:
a driving assembly to propel the vehicle at a vehicle speed;
a functional implement assembly to actuate a functional implement at a functional implement speed;
a vehicle speed sensor to monitor the vehicle speed; and
a controller to control the functional implement assembly to vary the functional implement speed proportionally to the vehicle speed.

2. The vehicle of claim 1, wherein the controller is to control the functional implement assembly to vary the functional implement speed directly proportional to the vehicle speed.

3. The vehicle of claim 2, wherein the vehicle comprises a lawn mower and the functional implement comprises a lawn mower blade.

4. The vehicle of claim 1, wherein the controller is to control the functional implement assembly to vary the functional implement speed directly proportional to the vehicle speed by:
determining whether the vehicle is on and that a current vehicle speed is substantially zero, and in response to determining that the vehicle is on and the current vehicle speed is substantially zero, setting the functional implement speed to a first functional implement speed; and
determining whether the current vehicle speed is greater than zero and less than a first vehicle speed, and
in response to determining that the current vehicle speed is greater than zero and less than the first vehicle speed, setting the functional implement speed to a second functional implement speed, the second functional implement speed greater than the first functional implement speed, and
in response to determining that the current vehicle speed is not greater than zero and less than the first vehicle speed, varying the functional implement speed directly proportional to the vehicle speed.

5. The vehicle of claim 4, wherein the vehicle further comprises an interface to set the first vehicle speed, the first functional implement speed, and the second functional implement speed.

6. The vehicle of claim 1, wherein the vehicle comprises an electrically-powered vehicle.

7. A vehicle comprising:
a driving assembly to propel the vehicle at a vehicle speed;
a functional implement assembly to actuate a functional implement at a functional implement speed;
a functional implement load sensor to monitor a load delivered to the functional implement; and
a controller to control the driving assembly to vary the vehicle speed proportionally to the functional implement load.

8. The vehicle of claim 7, wherein the controller is to control the driving assembly to vary the vehicle speed directly proportional to the functional implement load.

9. The vehicle of claim 8, wherein the vehicle comprises a seed spreader and the functional implement comprises a spreader disc.

10. The vehicle of claim 7, wherein the controller is to control the driving assembly to vary the vehicle speed inversely proportional to the functional implement load.

11. The vehicle of claim 10, wherein the vehicle comprises a snow blower and the functional implement comprises an auger.

12. The vehicle of claim 7, wherein the controller is to control the driving assembly to vary the vehicle speed directly proportional to the functional implement load by:
determining whether the vehicle is on and that a current functional implement load is substantially zero, and in response to determining that the vehicle is on and the current functional implement load is substantially zero, setting the vehicle speed to a first vehicle speed; and
determining whether the current functional implement load is greater than zero and less than a first functional implement load, and
in response to determining that the current functional implement load is greater than zero and less than the first functional implement load, setting the vehicle speed to a second vehicle speed, the second vehicle speed greater than the first vehicle speed, and
in response to determining that the current functional implement load is not greater than zero and less than the first functional implement load, varying the vehicle speed proportionally to the vehicle speed.

13. The vehicle of claim 12, wherein the vehicle further comprises an interface to set the first vehicle speed, the first functional implement speed, and the second functional implement speed.

14. The vehicle of claim 7, wherein the vehicle comprises an electrically-powered vehicle.
